(19) United States
(12) Patent Application Publication
(10) Pub. No.: US 2025/0059031 A1
(43) Pub. Date: Feb. 20, 2025

(54) METHOD FOR RECOVERING PROCESS CONDENSATE

(71) Applicants: thyssenkrupp Uhde GmbH, Dortmund (DE); thyssenkrupp AG, Essen (DE)

(72) Inventor: Thilo VON TROTHA, Selm (DE)

(73) Assignees: thyssenkrupp Uhde GmbH, Dortmund (DE); thyssenkrupp AG, Essen (DE)

(21) Appl. No.: 18/386,547

(22) Filed: Nov. 2, 2023

(30) Foreign Application Priority Data
Aug. 14, 2023 (DE) 10 2023 121 731.3

(51) Int. Cl. C01B 3/38; B01D 19/00; B01J 12/00; B01J 19/00; B01J 19/24

(52) U.S. Cl. CPC C01B 3/38; B01D 19/001; B01J 12/00; B01J 19/0013; B01J 19/24; B01J 2219/00103; B01J 2219/0011; B01J 2219/00157; C01B 2203/0233; C01B 2203/046; C01B 2203/0495; C01B 2203/0816; C01B 2203/0894; C01B 2203/1235; C01B 2203/148

(57) ABSTRACT

A method and a system for producing synthesis gas, wherein process condensate is used to produce steam. To this end, steam is used to strip volatile impurities, in particular carbon dioxide, from the process condensate and then preferably convert the impurities together with flue gas and discharge them. Then a pH of at least 7.0 is preferably set by adding additives, the process condensate being evaporated and recycled as output steam for producing synthesis gas. In this way, it is possible to suppress the corrosive effect of the process condensate such that no, or less, corrosion-resistant stainless-steel must be used in the manufacture of the system components that come into contact with the process condensate. The steam used to strip the volatile impurities is preferably generated by heat from the synthesis gas and/or flue gas.

### CROSS REFERENCE TO RELATED APPLICATION

This application is a U.S. Non-Provisional that claims priority to Belgian Patent Application No. DE 10 2023 121 731.3, filed Aug. 14, 2023, the entire content of which is incorporated herein by reference.

### FIELD

The present disclosure relates to a method and a system for producing synthesis gas, wherein process condensate is used to produce steam.

### BACKGROUND

According to conventional methods, synthesis gas is produced at high temperatures by the catalytic reaction of steam with hydrocarbons in a heated reforming reactor. The synthesis gas leaving the reforming reactor then contains a considerable amount of heat. A fuel gas is burned to heat the reforming reactor, and the flue gas produced by the combustion also contains a considerable amount of heat. The heat contained both in the synthesis gas and the flue gas is used to generate steam, which can be used to drive auxiliary systems or steam turbines, for example.

The water used for steam generation is often process water which is contained in the synthesis gas and accumulates as process condensate as the synthesis gas cools down. However, to meet the total steam demand of the system, it is desirable to provide a larger amount of steam, and the amount of steam from process condensate alone is often not sufficient for this purpose.

Therefore, additional steam is generated from boiler feedwater. Thus, in these known methods for producing synthesis gas, two types of steam are involved: steam from process condensate on the one hand and steam from boiler feedwater on the other. A process regime involving two steam systems has various advantages, one reason being that steam from process condensate and steam from boiler feedwater can be routed in such a way that the “clean” steam from boiler feedwater can be mixed in. The quality, especially the purity, of the steam to be exported is always ensured this way. In addition, this ensures that a sufficient amount of steam is always provided for the catalytic reaction with hydrocarbons in the heated reforming reactor.

Steam from boiler feedwater and steam from process condensate can each be generated by absorbing heat from the hot synthesis gas. For this purpose, boiler feedwater and/or process condensate is usually heated in a heat exchanger (preheater) and then evaporated in a steam generator. The steam generator can be designed as a steam drum heated using heat from the synthesis gas and/or flue gas.

WO 2009 118699 A2 relates to a method for producing synthesis gas from a furnace, the furnace comprising a combustion air stream, a convection section and a reformer flue gas stream.

WO 2010 051900 A1 relates to a method for heat utilization in steam reforming, comprising a high temperature conversion unit, a first heat exchanger, and subsequently a boiler feedwater preheater, product condensate heat exchanger, and low-pressure evaporator, and a cooling section in which the process gas is further cooled and a condensate stream is generated, and is passed through at least one unit for further processing the resulting process gas.

WO 2012/031683 A1 describes a method for generating process steam and boiler feedwater steam in a heatable reforming reactor for producing synthesis gas. The method according to the disclosure makes it possible to use the sensible heat of a synthesis gas produced from hydrocarbons and steam such that two kinds of steam are obtained, respectively produced by heating and evaporating boiler feedwater and process condensate, and wherein the method also converts the carbon monoxide contained in the synthesis gas, and wherein the method optionally heats the boiler feedwater using the flue gas that results from heating the reforming reactor.

However, the process condensate contains impurities from the synthesis gas, in particular organic fractions such as methanol, formic acid and carbon dioxide. In addition, the process condensate may also contain small amounts of non-volatile substances, such as iron, nickel or copper.

These impurities have undesirable effects, so that steam from process condensate cannot be used without restrictions. Steam turbines must meet strict operational requirements, which steam from process condensate does not always fulfil. Therefore, steam from process condensate is used in particular as steam for purposes of steam reforming (output steam), i.e. for catalytic reaction with hydrocarbons in the heated reforming reactor.

In contrast to steam from process condensate, steam from boiler feedwater does not contain any impurities and thus also meets the strict requirements placed on the operation of steam turbines. Steam from boiler feedwater can therefore be used in many ways, it can be exported, used to operate auxiliary systems or steam turbines, or it can be used as steam for steam reforming (output steam), i.e. for catalytic reaction with hydrocarbons in the heated reforming reactor. In addition, steam from boiler feedwater can be mixed with steam from process condensate to reduce the concentration of impurities in the mixture and thus, if necessary, meet any particular purity requirements that apply to the respective use of the steam.

Due to the corrosive effect of the impurities in the process condensate, all system components in large-scale systems for the generation, transfer and utilization of steam from process condensate (process condensate steam system) are made of stainless steel. In particular, the carbon dioxide dissolved in the process condensate would corrode carbon steel (C steel). The cost-related expenditure for the stainless-steel version, by comparison with carbon steel, is approximately 4 times higher.

Depending on the intended use of the process condensate, various purification methods are known from the prior art.

For example, process condensate can be pre-flashed and then degassed using steam, air or nitrogen in a scrubbing column. The impurities are discharged into the open air together with the purifying medium. Additional purification can be done by ion exchange using ion exchangers.

In order to improve environmental protection, purification methods have been developed which make it possible to separate additions from the process condensate and recycle them for synthesis gas production.

A method is known which is based on the distillation of process condensate in a stripping column or in a spray scrubber. The distillate, which contains the greater part of volatile components at a much higher concentration, is recycled for synthesis gas production and the liquid is additionally purified in an ion exchange system and used to feed steam boilers. However, one disadvantage of this method is the high cost of distillation of the dilute solutions. In addition, the process condensate is usually flashed prior to distillation, during which some of the additions escape into the open air.

A method is also known for the pre-purification of the process condensate, enabling the recovery of the additions contained in the condensate and the recycling thereof to the synthesis gas production step. This method is based on the removal of the volatile components by blowing them through a stripping column using natural gas or air (saturation process). However, the media used already contain components that are also contained in the process condensate, which makes complete removal of these components impossible. In addition, these media often contain non-volatile impurities, which then pass through into the pre-purified condensate. Moreover, systems for carrying out the saturation processes are expensive to procure and operate, especially if the process condensate to be purified is derived from the production of synthesis gas from coal or heavy petroleum products.

U.S. Pat. No. 4,193,776 A relates to a method for purifying the process condensate from synthesis gases or hydrogen systems. The process condensate is freed of impurities dissolved therein by stripping it using process steam before the process condensate is used in the chemical process of converting the raw materials to hydrogen or synthesis gas at a pressure equal to or greater than the pressure of this conversion process. All steam that contains volatile products from the degassing of process condensate is recycled to the gas generating process, and the process condensate is finally transported to the water treatment station before being used as boiler feedwater.

WO 2014 180923 A1 relates to a system and a method for treating, in a system for gasifying car-bon-containing fuels to form synthesis gas, condensate arising from a gasification of carbon-containing fuels to form synthesis gas, the condensate resulting from a cooling and purification of the synthesis gas, characterized in that the condensate is fed to a multistage evaporation device having a plurality of chambers, at least one heat exchanger and at least one condensate heating device, the condensate being heated in the heating device to a predefinable temperature at a predefinable pressure and then being fed, in countercurrent flow relative to the condensate flowing to the heating device, to one of the chambers, at least partial evaporation of the condensate by flash evaporation taking place therein, and the resulting gaseous medium therein being used in a heat exchanger for heating the condensate flowing to the heating device and at least partially liquefying, forming a distillate.

The conventional methods for generating steam from process condensate derived from the production of synthesis gas are not satisfactory in every respect, and there is a need for improved methods. In particular, there is a need for more cost-effective systems that do not use highly corrosion-resistant materials or reduce the amount of such materials.

Thus a need exists for a method and a system for producing synthesis gas, wherein process condensate is used to produce steam in a more efficient manner.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows schematic of a conventional system having a process flow.

FIG. 2 shows a system having a process flow according to the disclosure.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The disclosure relates to a method and a system for producing synthesis gas, wherein process condensate is used to produce steam. To this end, steam is used to strip volatile impurities, in particular carbon dioxide, from the process condensate and then preferably convert the impurities together with flue gas and discharge them. Then a pH of at least 7.0 is set, preferably by adding additives, and the process condensate is evaporated and recycled for synthesis gas production as steam for steam reforming (output steam). In this way, it is possible to suppress the corrosive effect of the process condensate such that no, or less, corrosion-resistant stainless-steel must be used in the manufacture of the system components that come into contact with the process condensate. The steam used to strip the volatile impurities is preferably generated by heat from the synthesis gas and/or flue gas.

It was surprisingly found that process condensate can be beneficially reused if the volatile impurities, especially carbon dioxide, are stripped out using steam. The steam used in this method can be generated from heat derived from the overall process for producing synthesis gas. The resultant exhaust gas, together with the impurities it contains, can be routed to the flue gas duct and thus discharged in an environmentally friendly manner.

The process condensate can be used to produce new steam from process condensate, after adjustment to a pH of at least 7.0 if necessary, without having to take special corrosion protection measures.

A first aspect of the disclosure relates to a method for producing synthesis gas, comprising the steps of:
(a) providing a feed stream comprising steam from process condensate and a hydrocarbon;
(b) reforming the feed stream using a supply of heat generated by the burning of fuel gas, wherein synthesis gas is obtained by reforming the feed stream and wherein flue gas is obtained by the burning of fuel gas;
(c) cooling the synthesis gas and condensing out the H₂O contained therein, thereby obtaining process condensate containing a dissolved volatile impurity;
(e) separating at least a portion of the volatile impurity from the process condensate by stripping it using steam, thereby obtaining degassed process condensate and exhaust gas comprising the separated volatile impurity;
   (i) evaporating the degassed process condensate by absorbing heat from synthesis gas and/or from flue gas, thereby obtaining steam from process condensate; and
   (j) recycling at least a portion of the steam from process condensate obtained in step (i) to step (a).

The method according to the disclosure comprises steps (a), (b), (c), (e), (i) and (j), preferably in alphabetical order. The method according to the disclosure may comprise further steps, for example one or more of steps (d), (f), (g) and (h), which are explained in more detail below, preferably also in alphabetical order.

In step (a) of the method according to the disclosure, a feed stream is provided comprising steam from process condensate and hydrocarbon.

The hydrocarbon is preferably methane, which is preferably provided as natural gas. However, according to the disclosure, the reforming of other hydrocarbons is also possible, which may originate from other suitable sources.

The feed stream may possibly contain further components which are known to a person skilled in the art and are common in the production of synthesis gas.

In step (b) of the method according to the disclosure, the feed stream is reformed using a supply of heat generated by burning fuel gas, wherein synthesis gas is obtained by reforming the feed stream, and wherein flue gas is obtained by burning fuel gas.

A hydrocarbon is also preferably used as the fuel gas, more preferably methane, which is also preferably provided as natural gas. According to the disclosure, however, it is also possible to use other hydrocarbons as the fuel gas, which may come from other suitable sources.

The fuel gas is combusted. For this purpose, it is preferably mixed with air or another oxygen-containing gas. The flue gas produced during the combustion of the fuel gas is preferably transferred to a flue gas duct and finally discharged to the environment via a chimney. However, since a large amount of heat is contained in the flue gas, this is preferably first cooled down over preferably several steps. In the course of this, the flue gas releases heat to suitable heat transfer media which allow the heat to be transported away and used elsewhere.

The reforming according to the disclosure is preferably carried out in a reforming reactor which is preferably designed as a primary reformer. Suitable reforming reactors are known to a person skilled in the art. Preferably, the reforming reactor comprises a plurality of tubes which are filled with catalyst and in which the conversion of hydrocarbon and steam to synthesis gas takes place (steam reforming). Suitable catalysts are known to a person skilled in the art. To provide the heat required for reforming, the fuel gas is combusted in a plurality of combustion chambers using suitable burners in the presence of air or the other oxygen-containing gas. A portion of the combustion heat flows from the combustion chambers through the reactor walls (tubes) and heats the feed stream and the catalyst located in the tubes.

The synthesis gas formed by the reforming process is preferably subjected to measures which are common on an industrial scale and are known to a person skilled in the art. Such measures preferably include, for example, soot separation, water removal and drying, separation of sulfur com-pounds, setting of the desired CO:H₂ ratio and CO₂ separation. Raw hydrogen gas is then separated from the synthesis gas treated in this way, and can be used for industrial operations such as the production of ammonia, for example.

However, since a large amount of heat is also contained in the synthesis gas, this is preferably first cooled over preferably several steps. In the process, the synthesis gas also gives off heat to suitable heat transfer media, with the aid of which the heat can be transported away and used elsewhere.

In step (c) of the method according to the disclosure, the synthesis gas is cooled. The synthesis gas contains H₂O which is present in liquid form or in gaseous form as steam, depending on the temperature level. After preferably several successive heat transfers and passing through descending temperature levels, the H₂O contained in the synthesis gas is condensed out, thereby obtaining process condensate. Since the H₂O has previously been in contact with the other ingredients of the synthesis gas, the process condensate typically comprises impurities, in particular at least one dissolved volatile impurity, preferably carbon dioxide. In addition to carbon dioxide, the process condensate may contain other volatile impurities that the H₂O has previously absorbed from the synthesis gas, for example formaldehyde, formic acid, etc. In addition, the process condensate may also contain non-volatile impurities.

Particularly because of the carbon dioxide content, the process condensate typically initially has a pH of less than 7.0.

In preferred embodiments, the method according to the disclosure comprises the additional step of
(d) preheating the process condensate by absorbing heat from synthesis gas and/or flue gas; preferably synthesis gas.

Suitable devices for preheating the process condensate are known to a person skilled in the art and include suitable heat exchangers.

In step (e) of the method according to the disclosure, at least a portion of the volatile impurity is separated from the process condensate by stripping using steam, thereby obtaining degassed process condensate and exhaust gas comprising the separated volatile impurity. The separated volatile impurity is preferably carbon dioxide, which is present as carbonic acid dissolved in the process condensate. Other volatile impurities may include, for example, hydrogen, nitrogen, methane, argon, hydrogen sulfide, sulfur dioxide, hydrogen cyanide, formic acid, hydrogen chloride and ammonia.

Preferably, the process condensate which is to be thermally degassed is first flashed from an elevated process pressure, preferably of approx. 25-30 bar, and then degassed using steam. This elevated process pressure of the process condensate preferably exists at first when the raw hydrogen gas and the process condensate are separated from each other in a process condensate separation device, for example a process condensate separator.

Preferably, step (e) is carried out in a process condensate degasser supplied with the steam.

Preferably, the content of carbon dioxide in the process condensate after step (e) is at most 150 ppmw, more preferably at most 100 ppmw, still more preferably at most 75 ppmw, most preferably at most 50 ppmw, and in particular at most 25 ppmw. Preferably, practically all of the carbon dioxide is separated from the process condensate in the process condensate degasser.

Preferably, the steam used to strip the volatile impurity is generated by absorbing heat from synthesis gas and/or flue gas. According to the disclosure, the process condensate degasser is therefore preferably driven by the residual heat system. The steam is preferably present as low-pressure steam.

Suitable process condensate degassers are known to a person skilled in the art and differ fundamentally in design and mode of operation from other devices for stripping dissolved volatile constituents, for example stripping columns.

Thermal degassing is preferably carried out at a pressure slightly above ambient pressure. In the process condensate degasser, the steam, preferably low-pressure steam, is preferably introduced by a suitable device at a pressure of preferably 1 to 2 bar gauge. This heats up the process condensate, and the volatile impurities and any additional gas components contained are physically/thermally stripped. Such a process regime has the advantage that the recovered exhaust gas can be fed in accordance with the disclosure to the flue gas duct, which is connected to the environment via a chimney. In this way, the pressure level of the recovered exhaust gas is compatible with the pressure level of the flue gas in the flue gas duct.

In preferred embodiments, the process condensate degasser is designed as a trickle degasser. A trickle degasser is preferably designed as a vertical pressure vessel with trickling tray internals, the pressure vessel being built directly onto a downstream feedwater tank. In the water space of the feedwater tank there is preferably a device for heat supply, usually a nozzle tube for direct injection of heating steam. Condensate and make-up water flow preferably from top to bottom through the degasser. This preferably increases the surface area due to the trickling over the trickling tray internals, facilitating heat and mass transfer processes. Steam flows preferably from bottom to top through the degasser, flowing around the water to be degassed (process condensate), preferably in cross-counterflow fashion. In the upper part of the degasser, most of the steam condenses in the incoming water, thereby heating it preferably to its boiling temperature. The remaining part of the steam exits the top of the degasser as exhaust vapour, taking with it the gases removed from the water that have passed into the vapour phase (exhaust gas). In the water space of the feedwater tank, continuous circulation, mixing and post-degassing of the water takes place, preferably due to the continuous supply of heat (https://www.ewt-was-ser.de/de/produkt/entgaser-speisewasserbehaelter.html).

According to the disclosure, however, other devices known to a person skilled in the art can also be used which are suitable as process condensate degassers and which can be supplied with steam.

A system with a capacity of 100 000 Nm3/h produces about 50 t/h of process condensate, which is preferably treated in this way according to the disclosure.

In preferred embodiments, the method according to the disclosure comprises the additional step of
(f) introducing the exhaust gas into the flue gas.

Preferably, the flue gas into which the exhaust gas is introduced has a temperature of at least 800° C. At these temperatures, for example, all hydrocarbon fractions are reliably decomposed so that there are no longer any environmental concerns. The presence of ammonia also has a positive effect on the reduction of nitrogen oxides.

According to the disclosure, the volatile impurities (gases) which are thermally removed from the process condensate are therefore not fed to the gas production process (hydrogen or synthesis gas), but to the flue gas duct which routes the combustion exhaust gases from the steam methane reforming process (SMR), i.e. in particular the products of the combustion of the fuel gas, through a heat exchanger section.

In preferred embodiments, the method according to the disclosure comprises the additional step of
(g) metering additive into the degassed process condensate, thereby obtaining degassed process condensate with additive.

Preferably, the additive is a base. Suitable bases are known to a person skilled in the art. Sodium hydroxide solution and aqueous ammonia are preferred according to the disclosure, especially aqueous ammonia.

Preferably, the degassed process condensate with additive has a pH of at least 7.0. The water recovered in this way (process condensate) can be processed in pipelines and containers made of carbon steel or low-alloy steels without any risk of corrosion.

In preferred embodiments, the method according to the disclosure comprises the additional step of
(h) preheating the degassed process condensate or the degassed process condensate with additive by absorbing heat from synthesis gas and/or flue gas; preferably from flue gas.

In step (i) of the method according to the disclosure, the degassed process condensate is evaporated by absorbing heat from synthesis gas and/or from flue gas, thereby obtaining steam from process condensate.

In step (j) of the method according to the disclosure, at least a portion of the steam from process condensate obtained in step (i) is recycled to step (a).

Another aspect of the disclosure relates to a system for producing synthesis gas, comprising:
a reforming reactor which is configured to reform a feed stream comprising steam from process condensate and hydrocarbon and which is heatable by supplying heat generated by burning fuel gas, wherein synthesis gas is obtained by reforming the feed stream and wherein flue gas is obtained by burning fuel gas;
downstream of the reforming reactor in the direction of flow of the synthesis gas, one or more devices configured to cool the synthesis gas and to condense out the H₂O contained therein, thereby obtaining process condensate comprising a dissolved volatile impurity;
downstream of the one or more devices in the direction of flow of the process condensate, a process condensate degasser configured to separate at least a portion of the volatile impurity from the process condensate by stripping using steam, thereby obtaining degassed process condensate and exhaust gas comprising the separated volatile impurity;
in the direction of flow of the degassed process condensate, one or more devices configured to evaporate the degassed process condensate by absorbing heat from synthesis gas and/or from flue gas, thereby obtaining steam from process condensate; and
a line configured to recycle at least a portion of the steam obtained from process condensate to the reforming reactor.

The system according to the disclosure is preferably configured to carry out the process described above. Preferred embodiments of the method according to the disclosure also apply analogously to the system according to the disclosure.

In preferred embodiments, the system according to the disclosure comprises an additional line for introducing the exhaust gas into the flue gas.

In preferred embodiments, the system according to the disclosure comprises an additive metering device downstream of the process condensate degasser and upstream of the one or more devices in the direction of flow of the degassed process condensate, the additive metering device being configured to meter additive into the degassed process condensate, thereby obtaining degassed process condensate with additive.

In preferred embodiments, the system according to the disclosure comprises a first process condensate preheater upstream of the process condensate degasser in the direction of flow of the process condensate, the preheater being configured to preheat the process condensate by absorbing heat from synthesis gas and/or flue gas; preferably from synthesis gas.

In preferred embodiments, the system according to the disclosure comprises a second process condensate preheater downstream of the process condensate degasser and preferably downstream of the additive metering device in the direction of flow of the degassed process condensate, the second process condensate preheater being configured to preheat the degassed process condensate or the degassed process condensate with additive by absorbing heat from synthesis gas and/or flue gas; preferably from flue gas.

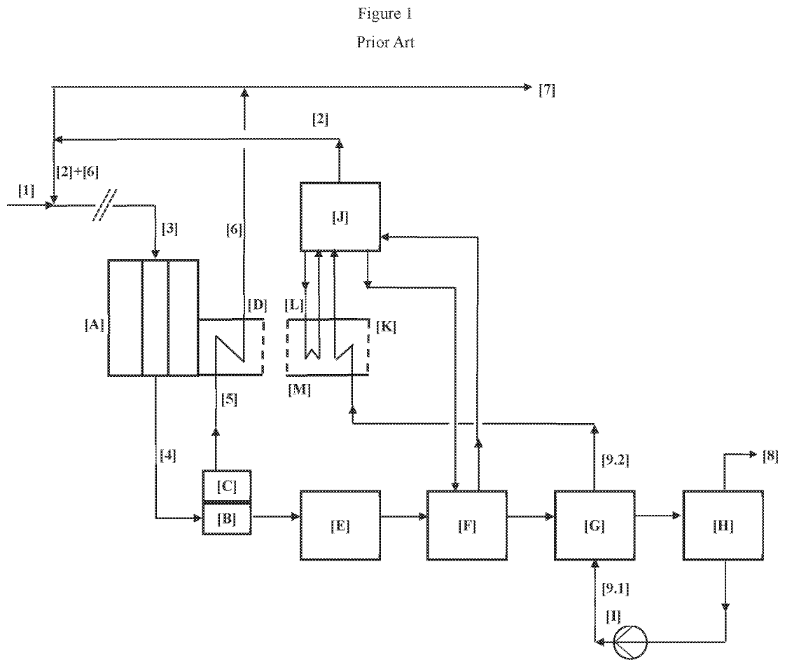

FIG. 1 shows a device and process regime according to the prior art, wherein hydrocarbon [1] and steam from process condensate [2] are combined and fed as a feed stream [3] to a reforming reactor [A]. The reforming reactor [4] is heated by burning a fuel gas, and the flue gas produced as a result is routed to a flue gas duct. The flue gas duct is only shown in sections, as indicated by the dashed lines.

The reformed gas [4] (synthesis gas) produced in the reforming reactor [A] is cooled in a process gas cooler [B]. The heat absorbed from the reformed gas [4] is utilized in a steam drum [C] to produce saturated steam from boiler feedwater [5], which then absorbs further heat from the flue gas in a steam superheater [D], producing superheated steam from boiler feedwater [6]. The superheated steam from boiler feedwater [6] can then be discharged as exported steam [7]. Alternatively, the superheated steam from boiler feedwater [6] can be combined with fresh steam from process condensate [2] and fed to the reforming reactor [A]. It is also possible to split the superheated steam from boiler feedwater [6] into two stream portions, one of which is exported and the other of which is recycled.

The reformed gas [4] cooled in the process gas cooler [B] passes through a CO conversion unit [E] and then through a process condensate evaporation unit [F]. In the process condensate evaporation unit [F], process condensate absorbs heat from the reformed gas [4]. The process condensate heated in this way is fed to a process condensate steam drum [J] in which steam is generated from the heated process condensate [2]. The steam from process condensate [2] is fed to the reforming reactor [A] as steam for steam reforming (output steam).

The reformed gas [4] further cooled in the process condensate evaporation unit [F] passes through a first process condensate preheater [G] and then through a process condensate separator [H] in which raw hydrogen gas [8] is separated from cold process condensate [9.1]. The cold process condensate [9.1] is recycled to the first process condensate preheater [G] by a process condensate pump [I] and absorbs heat from the reformed gas [4].

The process condensate [9.2] heated in the first process condensate preheater [G] is routed to a second process condensate preheater [K] where it absorbs further heat from the flue gas and is then evaporated in the process condensate steam drum [J]. The steam generated here from process condensate [2] is also fed to the reforming reactor [A] as steam for steam reforming (output steam). The process condensate steam drum [J] is additionally heated by heat from the flue gas via a flue gas heat exchanger [L] and is operatively connected to a convection tube bank [M].

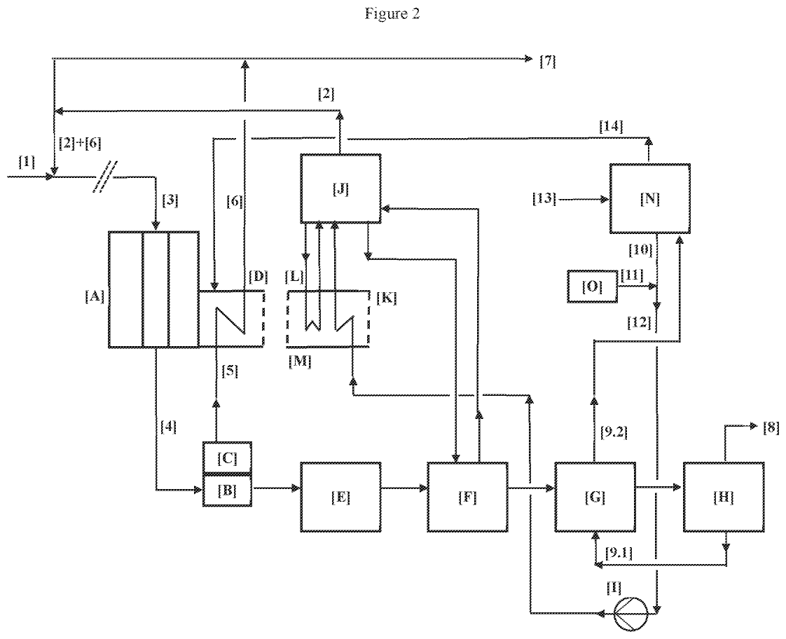

FIG. 2 shows a device and process regime according to the disclosure as a development of the prior art according to FIG. 1.

Compared to FIG. 1, the device additionally comprises a process condensate degasser [N] charged with steam for purposes of thermal degassing [13], as well as a device for metering in additive [O, 11]. The cold process condensate [9.1] produced in the process condensate separator [H] is also recycled to the first process condensate preheater [G] and heated therein, thereby obtaining preheated process condensate [9.2].

In contrast to the device and process regime as shown in FIG. 1, however, in the device and process regime as shown in FIG. 2, the process condensate [9.2] heated in the first process condensate preheater [G] is first fed to the process condensate degasser [N], where it is freed of impurities, in particular carbon dioxide, using steam for thermal degassing [13]. The degassed process condensate leaving the process condensate degasser [N] is admixed with additive using the additive metering device [O] and fed as degassed process condensate with additive [12] via the process condensate pump [I] to the second process condensate preheater [K].

The exhaust gas [14] leaving the process condensate degasser [N], together with the impurities, is introduced into the flue gas duct and is converted and discharged through it.

### LIST OF REFERENCE SIGNS

[1] Hydrocarbon
[2] Steam from process condensate
[3] Feed stream
[4] Reformed gas (synthesis gas)
[5] Saturated steam from boiler feedwater
[6] Superheated steam from boiler feedwater
[7] Exported steam
[8] Raw hydrogen gas
[9] Process condensate
[9.1] Cold process condensate
[9.2] Preheated process condensate
[10] Degassed process condensate
[11] Additive
[12] Degassed process condensate with additive
[13] Steam for thermal degassing
[14] Exhaust gas
[A] Reforming reactor
[B] Process gas cooler
[C] Steam drum
[D] Steam superheater
[E] CO conversion unit
[F] Process condensate evaporation unit
[G] First process condensate preheater
[H] Process condensate separator
[I] Process condensate pump
[J] Process condensate steam drum
[K] Second process condensate preheater
[L] Flue gas heat exchanger
[M] Convection bank
[N] Process condensate degasser
[O] Additive metering device

What is claimed is:

1. A method for producing synthesis gas [4] comprising:
(a) providing a feed stream [3] comprising hydrocarbon [1] and steam from process condensate [2];
(b) reforming the feed stream [3] using a supply of heat generated by burning fuel gas, wherein synthesis gas [4] is obtained by reforming the feed stream [3] and wherein flue gas is obtained by burning fuel gas;
(c) cooling the synthesis gas [4] and condensing out the H₂O contained therein, thereby obtaining process condensate [9] comprising a dissolved volatile impurity;
(e) separating at least a portion of the volatile impurity from the process condensate [9] by stripping using steam [13], thereby obtaining degassed process condensate [10] and exhaust gas [14] comprising the separated volatile impurity;
(i) evaporating the degassed process condensate [10] by absorbing heat from synthesis gas [4] and/or from flue gas, thereby obtaining steam from process condensate [2]; and
(j) recycling at least a portion of the steam from process condensate obtained during evaporating the degassed process condensate to providing the feed stream.

2. The method of claim 1, wherein separating at least a portion of the volatile impurity from the process condensate is carried out in a process condensate degasser [N] charged with the steam [13].

3. The method of claim 1, wherein the steam [13] is produced by absorbing heat from synthesis gas [4] and/or flue gas.

4. The method of claim 1, further comprising:
(d) preheating the process condensate [9] by absorbing heat from synthesis gas [4] and/or flue gas.

5. The method of claim 1, further comprising:
(f) introducing the exhaust gas [14] into the flue gas.

6. The method of claim 5, wherein the flue gas into which the exhaust gas [14] is introduced has a temperature of at least 800° C.

7. The method of claim 1, further comprising:
(g) metering additive [11] into the degassed process condensate [10], thereby obtaining degassed process condensate with additive [12].

8. The method according to claim 7, wherein the additive is a base.

9. The method according to claim 7, wherein the degassed process condensate with additive [12] has a pH of at least 7.0.

10. The method of claim 1, further comprising:
(h) preheating the degassed process condensate [10] or the degassed process condensate with additive [12] by absorbing heat from synthesis gas [4] and/or flue gas.

11. A system for producing synthesis gas [4], comprising:
a reforming reactor [A] which is configured to reform a feed stream [3] comprising steam from process condensate [2] and hydrocarbon [1] and which is heatable by supplying heat generated by burning fuel gas, wherein synthesis gas [4] is obtained by reforming the feed stream [3] and wherein flue gas is obtained by burning fuel gas;
downstream of the reforming reactor [A] in the direction of flow of the synthesis gas [4], one or more devices configured to cool the synthesis gas [4] and to condense out the H₂O contained therein, thereby obtaining process condensate [9] comprising a dissolved volatile impurity;
downstream of the one or more devices in the direction of flow of the process condensate [9], a process condensate degasser [N] configured to separate at least a portion of the volatile impurity from the process condensate [9] by stripping using steam [13], thereby obtaining degassed process condensate [10] and exhaust gas [14] comprising the separated volatile impurity;
in the direction of flow of the degassed process condensate [10], one or more devices configured to evaporate the degassed process condensate [10] by absorbing heat from synthesis gas [4] and/or from flue gas, thereby obtaining steam from process condensate [2]; and
a line configured to recycle at least a portion of the steam obtained from process condensate [2] to the reforming reactor [A].

12. The system of claim 11, having an additional line for introducing the exhaust gas [14] into the flue gas.

13. The system of claim 11, having an additive metering device [O] downstream of the process condensate degasser [N] and upstream of the one or more devices in the direction of flow of the degassed process condensate [10], the additive metering device [O] being configured to meter additive into the degassed process condensate [10], thereby obtaining degassed process condensate with additive [12].

14. The system of claim 11, having a first process condensate preheater [G] upstream of the process condensate degasser [N] in the direction of flow of the process condensate [9], the process condensate preheater [G] being configured to preheat the process condensate [9] by absorbing heat from synthesis gas [4] and/or flue gas.

15. The system of claim 11, having a second process condensate preheater [K] downstream of the process condensate degasser [N] and downstream of the additive metering device [O] in the direction of flow of the degassed process condensate [10], the second process condensate preheater [K] being configured for preheating the degassed process condensate [10] or the degassed process condensate with additive [12] by absorbing heat from synthesis gas [4] and/or flue gas.
